(19) United States
(12) Patent Application Publication
(10) Pub. No.: US 2009/0168612 A1
(43) Pub. Date: Jul. 2, 2009

(54) ELEMENT FOR INDICATING THE FASTENING TENSION OF A BAND, PARTICULARLY FOR A BRACELET FOR A PORTABLE DEVICE

(75) Inventors: Brice Robin, La Chaux-de-Fonds (CH); Baptist Wyssbrod, Nidau (CH); Nakis Karapatis, Premier (CH); Piotr Mazanowski, Solothurn (CH)

Correspondence Address: GRIFFIN & SZIPL, PC, SUITE PH-1, 2300 NINTH STREET, SOUTH, ARLINGTON, VA, 22204, US

(73) Assignee: ETA SA MANUFACTURE HORLOGERE SUISSE, Grenchen (CH)

(21) Appl. No.: 11/720,696

(22) PCT Filed: Nov. 11, 2005
(86) PCT No.: PCT/EP05/55923

§ 371 Date: Mar. 13, 2009

(30) Foreign Application Priority Data
Dec. 1, 2004 (EP) 04028457.2

(51) Int. Cl. G04B 37/14

(52) U.S. Cl. 368/282

(57) ABSTRACT

The invention concerns a fastening band (1) of the belt type or a wristband or bracelet for a portable device (40) for example, including fastening and length adjustment means (5). The fastening band includes an element (6, 42) for indicating the fastening tension thereof that has a specific visual appearance identifiable to the user in order to indicate to the latter when the fastening tension of the band is sufficient for a given application. The fastening band of the present invention is particularly interesting when it is implemented in the form of a wristband for a pulsometer worn on the wrist comprising optical type measuring means. In this application, a fastening tension value sufficient to guarantee proper measurement precision is predefined, the features of the indicator element being adapted to this value in order to indicate to the wearer that he has reached said value when the wristband is being fitted to his wrist.

### FIELD OF THE INVENTION

The present invention concerns a fastening band comprising at least first and second free ends and means for fastening and adjusting the length of the band.

Generally, this type of band can be implemented in the form of a holding strap for securing a certain number of objects to each other, or in the form of a belt, for example.

Preferably, the present invention concerns a band of this type when it is implemented as a strap or bracelet to make a device portable, such as for example a watch, secured to the user's arm.

### BACKGROUND OF THE INVENTION

Many bracelets or straps for portable devices, particularly watches, known from the prior art answer the above definition.

However, in the case of the use of a watch with multiple functions, for example a pulsometer using sensors placed in the back cover of the watch case and having to come into close contact with the wearers wrist, proper tightening of the band must be guaranteed when a measurement is being taken, and such tightening must be maintained during the entire pulsometer operation. Indeed, since such devices generally perform various operations such as calculating mean values from the pulse values measured over a given time, one must be able to ensure that no interruption to the measurement will falsify the mean value, so that the value displayed actually represents the effort provided during the given time.

The tightening of the band on the wearer's wrist must thus be able to be adjusted precisely, in order to place the watch in good pulse measuring conditions even in difficult working conditions, such as during a running race during which the wristband is subjected to significant shocks and vibrations.

U.S. Pat. No. 6,529,754 B2, granted on 4 Mar. 2003 in the name of Seiko Epson Corporation, provides a pulsometer comprising a wristband able to answer the aforementioned problem, because the wristband comprises zones of variable elasticity along its periphery. By way of example, this document provides one particular embodiment wherein the wristband comprises two main rigid parts and two links secured to the rigid parts and having a higher elastic value than that of the rigid parts.

Because of these additional highly elastic links, the case remains pressed against the users wrist even during significant wrist movements, particularly in rotation.

However, this solution does not provide means for indicating to the wearer of the pulsometer whether the wristband is sufficiently tightened to ensure that the case is properly pressed against his wrist and thus that the measurements have a proper level of precision. The patent in fact provides that the wearer of the pulsometer disclosed therein must tighten his wristband so as not to feel a sensation of too much compression, similar to the sensation felt when the a conventional watch is worn.

### SUMMARY OF THE INVENTION

It is an object of the present invention to overcome the aforementioned drawbacks of the prior art by proposing a fastening band that provides its user with data relating to the fastening tension of the band, in particular indicating when the fastening tension is suited to the corresponding conditions of use, in an intuitive and legible manner.

The invention thus concerns a fastening band of the aforementioned type, characterized in that it comprises, on the one hand, an element indicating the fastening tension able to have a specific visual configuration that is identifiable by the user for a tension value applied to the band substantially equal to a predefined value. The indicator element preferably includes one part that can deform elastically, delimited by first and second rigid ends.

Preferably, the band according to the present invention comprises one main portion, whereas the fastening tension indicator element is a link whose rigid ends have means for attachment to the main portion. Preferably, the deformable part of the link includes at least one hole that can be moved or deformed as a function of the band fastening tension in order to allow a mark to appear when the fastening tension reaches a sufficient value. Alternatively, the hole could have a first shape at rest and deform when the fastening tension increases to take a second predefined shape, when the fastening tension attains or exceeds the desired value.

In a preferred embodiment, the band fastening and length adjusting means comprise means for adjusting the length in a continuous manner.

Owing to these features, when the band according to the present invention is for example implemented in the form of a holding strap and it is used to secure fragile or deformable objects, the fastening tension thereof can be precisely adjusted to guarantee proper holding of the objects without any of them being damaged.

Moreover, according to a preferred application of the present invention, the band is implemented in the form of a wristband to allow a user to wear a multi-function watch type of device on the wrist. The advantage of a wristband answering the aforementioned features becomes clear when it is implemented in a watch that comprises, in particular, a function of measuring physiological data of the wearer, more specifically a pulsometer function whose measurements are taken by optical means. In such case, in fact, the features stated above enable the wearer of the watch to adjust the wristband fastening tension precisely to guarantee high quality measurements, without however feeling uncomfortable compression on his wrist.

### BRIEF DESCRIPTION OF THE DRAWINGS

Other features and advantages of the present invention will appear more clearly upon reading the following detailed description, made with reference to the annexed drawings, given by way of non-limiting example and in which:

FIG. 1 shows a schematic perspective view of a fastening band according to a first preferred embodiment of the present invention;

FIG. 2a shows a cross-section of a detail of the band shown in FIG. 1 in a first configuration;

FIG. 2b shows a similar cross-section to the view of FIG. 2a, in a different configuration of the band;

FIG. 3 shows a schematic perspective view of one part of a portable device provided with a band according to a second preferred embodiment of the present invention;

FIG. 4 is a similar view to that of FIG. 3 which shows a portable device provided with a band according to a third preferred embodiment of the invention;

FIG. 5 is a similar view to that of FIG. 4 which shows a portable device when the band is undergoing a tension substantially equal to a predefined value; and

FIG. 6 is a longitudinal cross-section, which shows the fastening tension indicator element fitted to the portable device of FIG. 4.

### DETAILED DESCRIPTION OF THE INVENTION

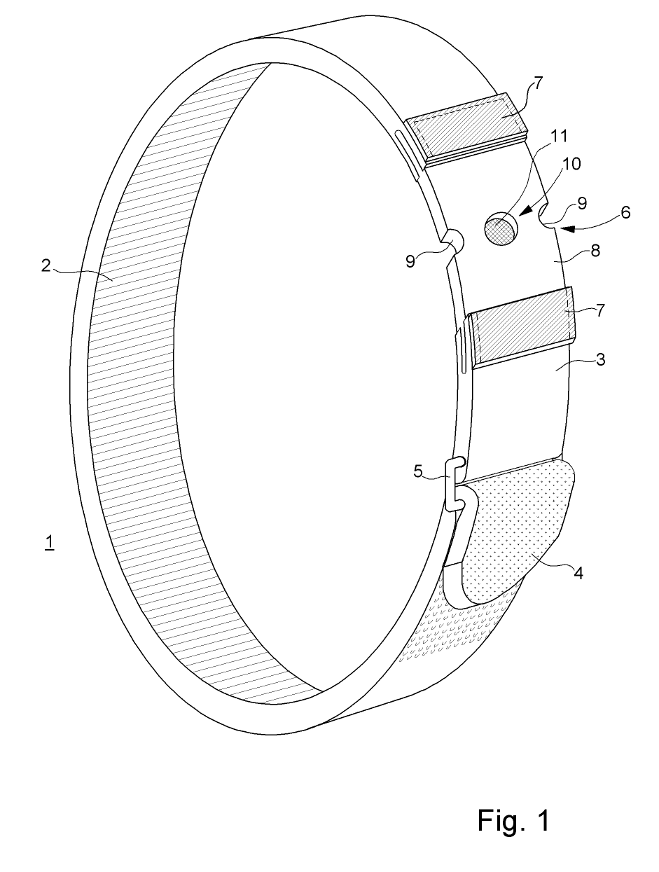

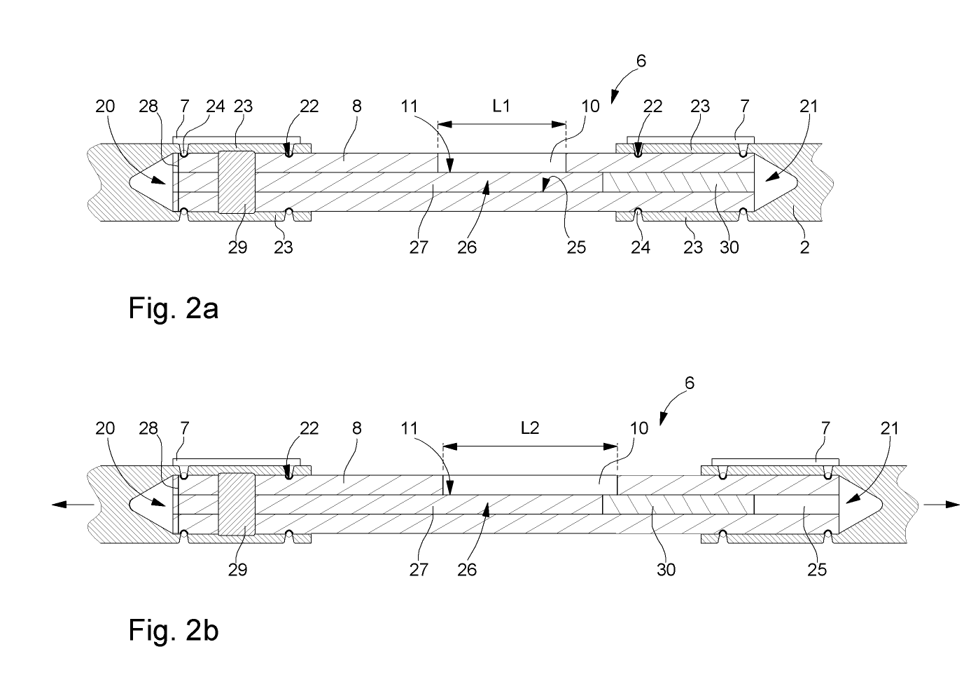

FIGS. 1, 2a and 2b show a fastening band according to a first general embodiment of the present invention.

FIG. 1 shows the fastening band 1 when it is fastened on itself. Band 1 includes a first main portion 2 having two free ends 3 and 4, connected to each other by the band fastening and length adjusting means.

The band fastening and length adjusting means can be implemented in several ways that are known in the state of the art. Preferred means are shown here, by way of indication, in the form of a buckle 5 secured to a first end 3 of band 1, for example by stitching. The second end 4 passes through buckle 5 and folds back on itself, means being provided to hold the second end securely against the main portion, i.e. the fix the length of band 1 in this position. By way of example, as shown in the diagram of FIG. 1, a system of complementary hooks and loops, such as those known under the commercial name of “Velcro”, distributed in a suitable manner on end 4 of the band and over the region of the main portion adjacent thereto.

Those skilled in the art will have no particular difficulty in adapting any known fastening system suitable for implementing the present invention. However, it should be noted that, as regards the means for fastening and adjusting the length of band 1, particular means allowing continuous adjustment of the band length are preferred for implementing the present invention. One could mention, by way of indication, an additional example of this type of fastening and adjusting system, namely, a fastening buckle of the type used on aircraft seatbelts, secured to a first end of the band and locking the second free end of the band by compression. Of course, the implementation of the present invention remains advantageous relative to known devices of the prior art even in cases where the band fastening and length adjustment means do not operate in a continuous manner.

The main portion 2 of the band can be made of any material that allows it to be both flexible and slightly elastic, such as for example, leather, a non-deformable natural or synthetic textile, or even plastic materials with low elasticity such as polyurethane, for example.

Moreover, band 1 comprises an additional portion 6, shorter than main portion 2. The arrangement of additional portion 6 along the circumference of band 1 is immaterial generally but it may be significant in some particular applications. Thus, in the case of the embodiment shown in FIG. 1, additional portion 6 is shown at a distance from end 3 of the band.

The connecting means implemented for integrating additional portion 6 in the circumference of main portion 2 of band 1 are more clearly visible in FIGS. 2a and 2b and will be examined in more detail below.

Optional decorative elements 7 for concealing the means for connecting additional portion 6 to main portion 2 have been shown by way of indication. These decorative elements 7 can be made of any suitable material, such as for example a conventional plastic, and may be advantageously used to affix the trademark of the manufacturer of band 1.

The additional portion 6 which fulfils a function of indicating the band fastening tension includes for this purpose a central part 8 having a high level of elasticity, particularly in the longitudinal direction of band 1. Further, central part 8 has a particular shape encouraging the deformation thereof in the longitudinal direction of band 1, namely lateral recesses 9.

Moreover, the central part 8 is provided with a hole 10 at the centre thereof, the function of which will be explained below in relation to the detailed description of FIGS. 2a and 2b. In a non-limiting preferred manner, hole 10 is circular in its rest configuration, as shown in FIG. 1 and allows a surface 11 of predefined texture to appear, such as for example a predefined colour.

FIG. 2a shows a cross-section of a detail of band 1 in the configuration shown in FIG. 1, the cross-section being taken along a plane intersecting the band in the middle thereof and extending in the longitudinal direction thereof.

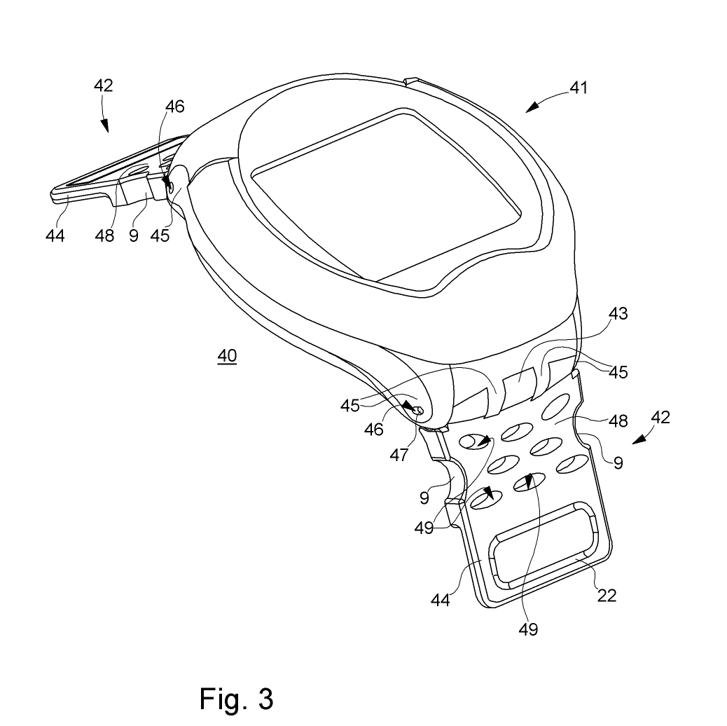

According to the preferred embodiment shown, additional portion 6 includes two rigid ends 20 and 21, on either side of elastic central portion 8. Each of these ends 20, 21 includes a groove 22, of substantially rectangular shape (visible in FIG. 3) for cooperating with means for attaching main portion 2. Each of the parts of main portion 2 connected to additional portion 6 is divided into two ends 23 that are symmetrical relative to the middle plane of the band and each comprising a small frame 24, made of rigid plastic or metal, which could be stitched onto or into the corresponding end 23. The shape and dimensions of each frame 24 are adapted to allow it to be inserted into groove 22 of the corresponding rigid end 20, 21 of the additional portion. Preferably, at each rigid end 20, 21 of additional portion 6, the two symmetrical ends 23 are stitched to each other at least on the sides and possibly through the corresponding rigid end 20, 21, such that each of frames 24 is securely held in its groove 22. This structure guarantees an efficient and reliable connection between the main and additional portions of band 1. Moreover, it should be noted that such connection means also reinforce the rigidity of the two ends 20, 21.

The decorative elements 7 cover the connection means of the main and additional portions, namely frames 24 and the stitching, on the outer side of the band, i.e. the side thereof that is visible when it is being used.

According to the embodiment shown by way of indication, additional portion 6 has a central hollow 25 of parallelepiped shape housing a plate 26 of complementary shape. Plate 26 is preferably made of a rigid material and may be arranged in additional portion 6 by over moulding. A first side 27 of plate 26 is secured to the rigid end 20 because of the arrangement of one part of stitching 28, securing both symmetrical ends 23 to each other, and because of the arrangement of a foot 29 passing through the two symmetrical ends 23 and plate 26. Of course, the present invention is not limited to the means for securing first side 27 of plate 26 that have just been described, which may be implemented independently of each other, or which may alternatively implement conventional bonding of first side 27 of the plate to the rigid end 20 of additional portion 6.

Two successive regions have been schematically shown in the plate in the longitudinal direction of the band, a first region corresponding to the first side 27, then a second region 30 extending from the end of the first region to the end of the plate located on the side of rigid end 21. The first region has a part 11 that is visible through hole 10 of central part 8. Preferably, the two regions 27, 30 have different colours that can easily be distinguished from each other, such as for example red and green.

It will be noted in FIG. 2a that the second region 30 is not visible through hole 10, the latter having a length at rest in the longitudinal direction referenced L1. Thus, in this configuration of the band, the user perceives a red disc through hole 10.

When band 1 is taut, as shown in FIG. 2b, in order to hold objects together for example, additional portion experiences increased tension, causing a deformation of its central elastic part 8. The deformation of central part 8 causes a deformation, particularly a stretch, of hole 10 such that the latter then has a length referenced L2 in the longitudinal direction of band 1, L2 being greater than L1.

It is also apparent from FIG. 2b that in addition to deforming, hole 10 moves to follow the more general deformation of central part 8, particularly until a part of second region 30 of plate 26 is visible. It should be noted in fact that, because of the previously described structure of additional portion 6, plate 26 does not undergo any movement or deformation in response to an increase in the fastening tension of band 1. Preferably, the user sees a green colour appearing at this stage next to the initial red colour, indicating to him that the fastening tension of the band has attained a sufficient value within the scope of the current use of band 1.

Consequently, for a predefined application of band 1, those skilled in the art know which optimum fastening tension the band should have when it is taut and they can thus provide the necessary deformation of hole 10 for allowing the second region 30 of plate 26 to appear and indicate to the user that the tension is sufficient. Thus, when the band is used for holding together fragile objects, these features may be adjusted during manufacture to guarantee an indication to the user of the tension necessary and sufficient to achieve this object, without damaging the objects.

Of course, indication of the fastening tension according to the present invention is not limited to the use of an element that changes colour as has just been described. One could simply provide the appearance of one colour or a change of texture in the broadest sense, the basic principle consisting in at least obtaining an appearance that can be identified by the user when the required fastening tension value is attained.

FIG. 3 shows a preferred embodiment of the band according to the present invention, when it is implemented as a wristband allowing a portable device 40, of the wristwatch type, to be worn on the wrist. The band according to the present embodiment is only partially shown in order to make certain details of its structure apparent.

The main portion (not shown) of the band is divided here into two similar strands between which the case 41 of a portable electronic device 40 is arranged.

According to a preferred implementation, the portable electronic device is a pulsometer including means for measuring the pulse of the wearer and electronic circuits for processing measurements and controlling display means for displaying the results obtained. Such electronic devices are known from the prior art and will not be described in more detail here, insofar as they do not directly contribute to the present invention. By way of indication, those skilled in the art could refer to the teaching of the U.S. patent mentioned by way of prior art in order to consult an example implementation of an electronic device having a function of measuring the wearer's heartbeat, in particular by the use of optical type measuring means.

The band fastening and adjusting means are no longer shown in FIG. 3, insofar as they can be implemented in a similar manner to that described in relation to the detailed description of FIG. 1. Alternatively, a conventional wristband fastening device could be implemented, of the buckle and tongue type cooperating with holes, combined with a specific device for adjusting the length of the wristband, of the type disclosed in EP Patent Application No. 1 588 640, filed on 23 Apr. 2004 in the name of The Swatch Group Management Services AG. Of course, those skilled in the art could implement any other known fastening and adjustment system suited to the implementation of the band described here without departing from the scope of the present invention.

FIG. 3 shows a preferred variant according to which the band includes two identical elements 42 indicating the band fastening tension, arranged on either side of case 41.

Each of these elements 42 includes two rigid ends 43 and 44, one 43 of which is connected to case 41. For this purpose, the case includes four horns 45 through which a cylindrical hole 46 is arranged, the rigid end 43 having a complementary shape suited to fitting between horns 45. Further, rigid end 43 also includes a cylindrical hole (not visible) arranged so as to be aligned with hole 46, a bar 47 for securing the horns and rigid end 43 to each other.

The second rigid end 44 is similar to the rigid end 21 described in relation to the detailed description of FIG. 2a of the preceding embodiment. Rigid end 44 includes a groove 22 of substantially rectangular shape for housing a rigid frame secured to the corresponding wristband strand (not shown). The strand is then preferably stitched to secure it to the indicator element or link 42, as described above.

The central part 48 of each indicator element 42 can be elastically deformed because of the elasticity of the central part that is greater than that of rigid ends 43, 44. The elasticity of central part 48 is due, in particular, to its peculiar structure. It will be noted in fact that central part 48 includes lateral recesses 9, identical to those described in relation to FIG. 1, for facilitating longitudinal deformations of indicator element 42 in response to an increase in the tension experienced between its two rigid ends.

Further, the central part 48 includes a plurality of through holes 49 each having a substantially elliptical shape. Thus, when the tension exerted on the wristband increases, central part 48 of each link 42 is deformed causing a deformation of holes 49.

As a function of certain parameters, such as the exact shape of holes 49 and the elastic properties of central part 48, which those skilled in the art can adjust without any difficulty, it is possible to define almost any type of predefined appearance, identifiable by the user, that one wishes to obtain for a predefined fastening tension of the wristband.

In particular, on the base of holes 49 shown in FIG. 3, the properties of each of links 42 could be defined such that, for a predefined fastening tension value, the holes undergo a deformation to have a circular shape or the shape of a rhomb.

Those skilled in the art will not encounter any particular difficulty in adjusting the choice of material of links 42 and the shape of holes 49 to obtain a predefined appearance identifiable by the user when the fastening tension corresponds to an optimum value for the application concerned.

Alternatively, one could provide a structure comprising one or several similar holes to holes 49 arranged in such a way that they undergo deformation when the band fastening tension increases, to form a marking when the fastening tension value is substantially equal to the desired value.

This solution advantageously enables the manufacturer of the band or device to affix his trademark to his product in an original manner.

The device shown in FIG. 3 corresponds to a preferred application of the band according to the present invention which should not be deemed limiting. Indeed, the wristband as it is described above has a particular advantage when it is implemented in a device having a pulsometer function whose measurements are taken using optical type measuring means. These measuring means generally include a light beam transmitter and a receiver for at least part of the light beams transmitted after they have propagated in the wearer's body. Consequently, the measurement results are sensitive to light sources outside the device, particularly to the ambient light. This is why it is important for the case of the portable device to be properly pressed against the wearer's skin. For this purpose, the fastening tension has to have a minimum value from which the ambient light cannot interfere with measurements. Thus, the wristband as partially shown in FIG. 3, not only presses the case properly against the wearer's wrist, even in the event of movements of the latter, owing to the elasticity of links 42 directly connected to the case, but also indicates to the wearer when the fastening tension is sufficient to ensure a high level of measurement reliability. This latter feature advantageously allows the wearer to adjust the grip tension precisely to such an extent that the comfort of the device is not affected.

According to a variant, one could provide a combination of the band fastening tension indicator elements according to the two embodiments described above. A fastening tension indicator element like that shown in FIG. 3 could comprise a hollow similar to hollow 25 of FIG. 2a, housing a plate similar to plate 26 and acting as a reference frame In such case, the plate includes, on its face 11, designs or markings corresponding to the position and shape of holes 49, when the latter are deformed in response to the desired band fastening tension value. This variant advantageously allows the wearer to identify the situation in which holes 49 have attained the desired shape more easily than in the embodiment of FIG. 3, but with a substantially more compact construction than the latter.

According to an additional variant, it is possible to omit holes 49 while making central part 48 complete and replacing holes 49 by simple designs arranged on the visible surface of central part 48. The designs can be formed in the mass of the central elastic part or printed on the surface thereof by any suitable method. It is then possible to adapt the mechanical properties of the central elastic part to make such designs, which, from any shape in the rest position of the central part, have any predefined shape identifiable by the user when the band fastening tension has reached a predefined value. In a similar manner to that described above, the designs obtained could, for example, be discs, rhombs or form a predefined identifiable inscription.

Within the scope of this variant, the designs could also be carried by an additional support element secured to the central elastic part, such as for example, in a non-limiting manner, by a thin silicon wafer duplicated moulded on the central elastic part or vice versa.

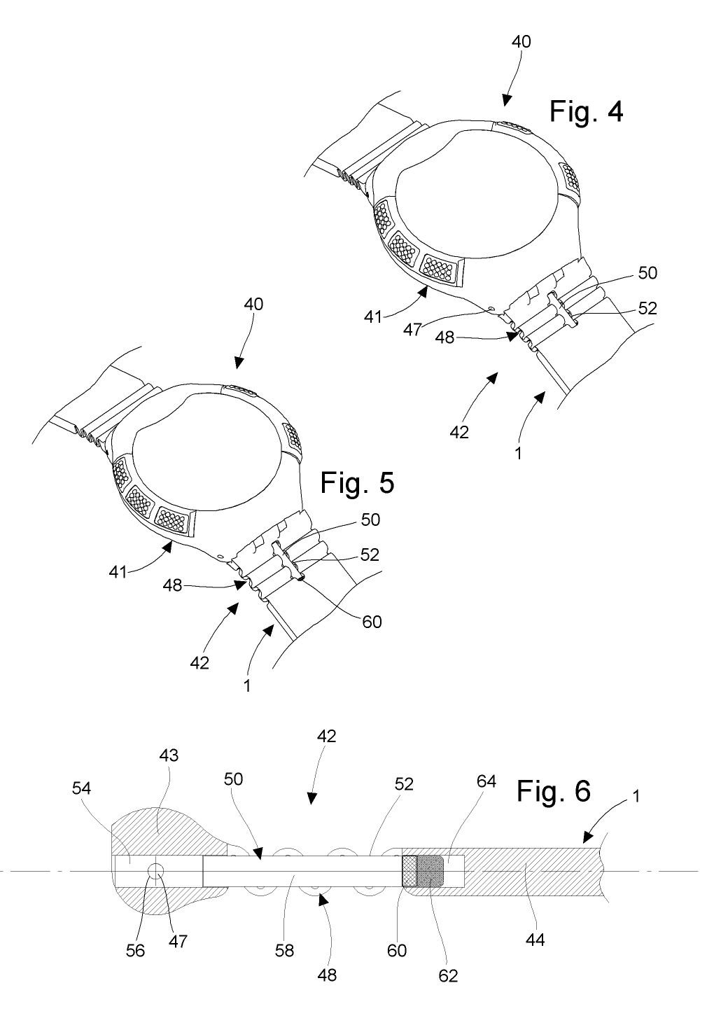

According to a third embodiment of the invention, which is shown in FIGS. 4 to 6, the fastening tension indicator element, or indicator element 42, is arranged at one end of wristband 1 to be secured to case 41, as in the portable electronic device 40 of FIG. 3, and the structure of indicator element 42 is of the same type as that described in relation to FIG. 1, the plate being replaced by a longitudinal stem 50 that extends into the thickness of indicator element 42 and that is partially visible through a display hole 52 arranged in central part 49 of indicator element 42.

For the description of the third embodiment, similar elements or elements having the same function as those used in the preceding embodiments will be designated by the same references.

According to the third embodiment, stem 50, which forms the reference element for the grip tension indication, is secured to case 41 with the corresponding rigid end 42 of indicator element 42, the connection of said rigid end 43 to case 41 being identical to that described with reference to the embodiment of FIG. 3. In order to be fixed, stem 50 comprises, at its securing end 54, a transverse hole 56 for the passage of bar 47, such that stem 50 is held on case 41 with rigid end 43 by bar 47.

Display hole 52 has the shape here of a longitudinal slot, of substantially equal width to the diameter of stem 50, in order to allow, in the rest configuration of indicator element 42, a first section 58 of stem 50 to appear, called the intermediate section, of determined colour or texture. On the opposite side to its securing end 54, stem 50 comprises a second section 60 which is adjacent to the first 58 and which has a different colour or texture to the latter, and a third section 62, which is adjacent to second section 60 and which has a different colour or texture to second section 60.

In the rest configuration of indicator element 42, the second 60 and third 62 sections are not visible in display hole 52 since they are received in a complementary cylindrical bore 64 made in the second rigid end 44 of indicator element 42. They are thus concealed under a portion of wristband 1.

As for the preceding embodiments, the central part 48 of indicator element 42 can be deformed elastically, because of the greater elasticity of that part relative to the elasticity of rigid ends 43, 44. Thus, the central part 48 is undulated here giving it a profile of sinusoidal shape and providing controlled elasticity for facilitating the longitudinal deformations of indicator element 42 in response to an increase in the tension experienced between the two rigid ends 43, 44 thereof.

When the tension value applied to wristband 1 is less than the predefined value, only intermediate section 58 is visible in display hole 52, as shown in FIGS. 4 and 6, such that the user knows that wristband 1 is not tightened sufficiently for the wristband's intended application.

When the tension value applied to wristband 1 attains or exceeds the predefined value, the second section 60, which is for example green, appears in display hole 52, as shown in FIG. 5, which indicates to the user that the wristband is sufficiently tightened for the current application.

Advantageously, the third section 62, which is for example red, appears when the tension value applied to wristband 1 is greater than or equal to another predefined value corresponding to an excessive wristband tension. This embodiment thus warns the user when the wristband is too tight, in order to prevent him injuring himself and preventing him from damaging wristband 1 and/or causing accelerated wear of the latter.

Preferably, stem 50 is sufficiently flexible to be able to follow the curvature of indicator element 42 when wristband 1 is being worn.

According to the embodiment shown here, indicator element 42 is moulded in a plastic material in a single piece with the corresponding wristband strand 1. Since the elasticity of central part 48 of indicator element 42 is obtained essentially via the sinusoidal profile thereof, and not by the actual elasticity of the material that forms indicator element 42, it is possible to make wristband 1 entirely in the same material, which minimises the manufacturing costs of wristband 1. Of course, indicator element 42 could also be made in the form of an indicator link added onto wristband strand 1, as in the embodiment of FIG. 3.

The preceding description corresponds to preferred embodiments of the invention and should in no way be considered limiting, as regards more particularly the structure described for the band fastening and length adjustment means or the means for connecting the various constituent elements of the band. Those skilled in the art will not encounter any particular difficulty in adapting the particular features of the band described to their particular requirements, in terms of materials, shape or dimensions without departing from the scope of the present invention.

1. A portable device including:
a case; and
a fastening band fulfilling the function of a wristband allowing the portable device to be worn, the fastening band including at least first and second free ends, means for fastening and adjusting the length of said band, wherein the fastening band comprises an element for indicating a fastening tension able to take on a specific visual configuration identifiable by a user for a value of said tension applied to said band substantially equal to a predefined value, said fastening tension indicator element including at least one part able to deform elastically, and wherein said deformable part is delimited by a first and a second rigid end of said fastening tension indication element.

2. The portable device according to claim 1, wherein the fastening band includes at least one main portion, said element being a link whose said rigid ends have attachment means for cooperating with suitable attachment means of said main portion.

3. The portable device according to claim 1, wherein said deformable part includes at least one hole whose section has a shape dependent upon the value of the tension applied to said band.

4. The portable device according to claim 3, wherein, when the value of the tension applied to said band is substantially equal to said predefined value, the hole has a circular or rhomb-shaped cross-section or defines an inscription.

5. The portable device according to claim 3, wherein said element further comprises reference means secured to one of said ends and carrying at least one design arranged to be located opposite said hole and to have the same shape as said hole when the value of the tension applied to said band is substantially equal to said predefined value.

6. The portable device according to claim 1, wherein said deformable part includes at least one design whose shape is dependent upon the value of the tension applied to said band.

7. The portable device according to claim 6, wherein said design is circular or rhomb-shaped, or defines an inscription when the value of the tension applied to said band is substantially equal to said predefined value.

8. The portable device according to claim 1, wherein said deformable part includes at least one hole whose position relative to at least one of said rigid ends depends upon the fastening tension value of said band, said indicator element further including reference means secured to said end and located at a distance from the latter such that said reference means have a specific predefined visual appearance for a value of the tension applied to said band that is substantially equal to a predefined value.

9. The portable device according to claim 8, wherein said reference means include two portions of different respective colours located in the extension of each other along the longitudinal direction of said band.

10. The portable device according to claim 9, wherein said reference means are formed by a longitudinal stem which is secured to said end and which includes a first section of a first colour or texture, and a second section of a second colour or texture, the second section being arranged on the side opposite to said securing end, and wherein the second section is concealed under one portion of the band, when the value of the tension applied to the band is less than the predefined value, and is visible in the hole, when the value of the tension applied to the band is substantially equal to a predefined value.

11. The portable device according to claim 10, wherein the stem includes a third section of a different colour or texture from the second section, the third section extending from the opposite side to the first section and wherein the third section is visible in the hole when the value of the tension applied to the band is greater than or equal to a predefined value corresponding to an excessive band tension.

12. The portable device according to claim 1, wherein said means for fastening and adjusting the length of said band include means for continuously adjusting said length.

13. The portable device according to claim 1, wherein a first of said free ends of said band includes means for cooperating with first suitable means of a first side of said case, the second of said ends being adapted to cooperate with said fastening and length adjusting means, the latter including means for cooperating with second suitable means of a second side of said case.

14. The portable device according to claim 13, wherein said band includes a fastening tension indicator element taking the form of a link of which a first of said rigid ends carries attachment means for cooperating with suitable means of said case.

15. The portable device according claim 1, wherein said band includes at least two strands arranged on either side of said case and each carrying one of said free ends, at least one of the two strands including an element indicating the fastening tension of said band.

16. The portable device according to claim 15, said free ends being connected to said means for fastening and adjusting the length of said band, wherein at least one band fastening tension indicator element is arranged between one of said free ends and said case.

17. The portable device according to claim 16, wherein said band fastening tension indicator element is directly connected to the case.

18. The portable device according to claim 17, wherein a second said band fastening tension indicator element is directly connected to the case.

19. The portable device according to claim 10, wherein the band includes at least one fastening tension indicator element of which a first rigid end carries attachment means for cooperating with suitable means of the case, and wherein the stem cooperates with the suitable means of the case in order to be secured to the case.

20. The portable device according to claim 13, wherein it includes means for measuring physiological data of the wearer thereof, said measuring means being integrated in said case.

21. The portable device according to claim 20, wherein the device includes a pulsometer function, optical measuring means being arranged on one face of said case that will be arranged against said user's arm.

22. The portable device according to claim 1, wherein the device is a watch.
